(19) United States
(12) Patent Application Publication
(10) Pub. No.: US 2005/0246438 A1
(43) Pub. Date: Nov. 3, 2005

(54) Access control for packet-oriented networks

(76) Inventor: Michael Menth, Oellingen (DE)

Correspondence Address: Siemens Corporation;Intellectual Property Department, 170 Wood Avenue South, Iselin, NJ, 08830, US

(21) Appl. No.: 10/524,479

(22) PCT Filed: Aug. 14, 2003
(86) PCT No.: PCT/DE03/02737

§ 371 Date: Feb. 11, 2005

(30) Foreign Application Priority Data
Aug. 14, 2002 (DE) 102 37 333.7

(51) Int. Cl. G06F 15/173

(52) U.S. Cl. 709/224; 709/225

(57) ABSTRACT

The invention relates to a method for access control to a packet-oriented network. Two admissibility checks for a group of packets are carried out by means of threshold values for the traffic transmitted via the network input node and the network output node for the flow. The transmission of the groups of data packets is not permitted when an authorization of the transmission would lead to traffic volume exceeding one of the threshold values. A relationship between the threshold values and the traffic volume in partial stretches or links may be formulated by means of the proportional traffic volume over the individual partial stretches. Using the capacities of the links the threshold values for pairs of input and output nodes can be fixed such that no overload occurs on the individual links. Within the above method a flexible reaction to the drop-out of links can be achieved by means of a resetting of the threshold values. Furthermore the inclusion of other conditions is possible, for example relating to the capacity of interfaces to other networks or special demands on transmission of prioritized traffic.

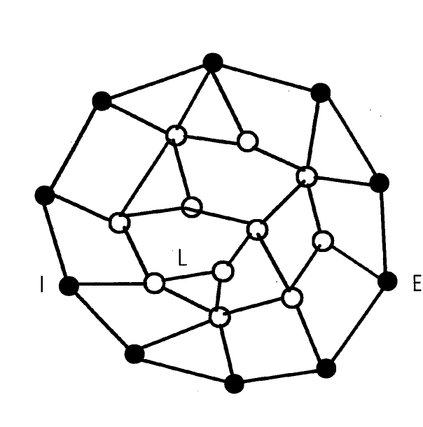

### CROSS REFERENCE TO RELATED APPLICATIONS

This application is the US National Stage of International Application No. PCT/DE2003/002737, filed Aug. 14, 2003 and claims the benefit thereof. The International Application claims the benefits of German application No. 10237333.7 filed Aug. 14, 2002, both applications are incorporated by reference herein in their entirety.

### FIELD OF THE INVENTION

The invention relates to a method for restricting traffic in a packet-oriented network.

### BACKGROUND OF THE INVENTION

development of technologies for packet-based networks is currently a central focus of activity for engineers in the fields of network technology, switching technology and internet technologies.

The main objective is to be able to use a packet-oriented network for any services as far as possible. Packet-oriented networks are traditionally used for time-uncritical data transmissions, e.g. transfers of files or electronic mail. Voice transmission with real time requirements is traditionally effected via telephone networks using time multiplex technology. TDM (time division multiplexing) networks are also frequently referred to in this context. The provision of networks with high bandwidths and transmission capacities has made the implementation of image-related services feasible, as well as data and voice transmission. The transmission of video information in real time, e.g. in the context of video on demand services or video conferences, will be an important service category in future networks.

development aims at making it possible to implement all services—data-related, voice-related and video-information-related—as far as possible via a packet-oriented network. Classes of service are generally defined for the differing requirements for data transmission in the context of the various services. Transmission with a defined quality of service, primarily for services with real time requirements, requires corresponding control for packet transmission via the network. There are a series of terms relating to traffic control: traffic management, traffic conditioning, traffic shaping, traffic engineering, policing, etc. Different procedures for controlling the traffic in a packet-oriented network are described in the relevant literature.

In the case of ATM (asynchronous transfer mode) networks a reservation is made for every data transmission on the entire transmission link. Reservation restricts the traffic volume. An overload control takes place on each section for monitoring purposes. Any discarding of packets takes place on the basis of the CLP (cell loss priority) bit in the packet header.

The Diff-Serv concept is used in IP (internet protocol) networks and is intended to achieve better quality of service for services with stringent quality requirements by introducing classes of service. A CoS (class of service) model is also frequently referred to in this context. The Diff-Serv concept is described in the RFCs published by the IETF with the numbers 2474 and 2475. In the context of the Diff-Serv concept, packet traffic is prioritized using a DS (Differentiated Services) field in the IP header of the data packets by setting the DSCP (DS code point). Such prioritization is achieved using “per hop” resource allocation, i.e. the packets are handled differently at the nodes depending on the class of service specified in the DS field by the DSCP parameter. Traffic control is thus implemented based on classes of service. The Diff-Serv concept results in privileged handling of traffic with prioritized classes of service but not reliable control of traffic volume.

Another approach to transmission via IP networks in respect of quality of service is provided by the RSVP (resource reservation protocol). This protocol is a reservation protocol, which is used to reserve bandwidth along a path. A quality of service (QoS) transmission can then take place via this path. The RSVP protocol is used together with the MPLS (multi protocol label switching) protocol, which allows virtual paths via IP networks. To guarantee QoS transmission, the traffic volume is generally controlled and where necessary restricted along the path. The introduction of paths however leads to the loss of much of the original flexibility of IP networks.

Efficient control of traffic is central to the guarantee of transmission quality parameters. When controlling the traffic volume in the context of data transmission via packet-oriented networks, a high level of flexibility and low level of complexity should also be ensured for data transmission, as shown for example by IP networks to a large degree. This flexibility or low level of complexity is however largely lost again when using the RSVP protocol with end to end path reservation. Other methods such as Diff-Serv do not result in guaranteed classes of service.

### SUMMARY OF THE INVENTION

The object of the invention is to specify an efficient traffic control for a packet-oriented network, which avoids the disadvantages of conventional methods.

The object is achieved by the claims.

In the context of the method according to the invention two admissibility checks are carried out for a group of data packets of a flow to be transmitted via the network. The first admissibility check is carried out using a limit value for the traffic routed via the network ingress node for the flow and the second using a limit value for the traffic routed via the network egress node for the flow. Transmission of the group of data packets is not permitted, if authorization of the transmission would result in a traffic volume exceeding one of the two limit values.

The two admissibility checks are carried out for example at the network ingress node and network egress node for the flow. In this case the result relating to the traffic routed via the network egress node is for example transmitted to the network ingress node, so that transmission of the group of data packets is permitted or not permitted there on the basis of the results of the two admissibility checks.

The packet-oriented network can also be a sub-network. In IP (internet protocol) systems there are for example network architectures, in which the entire network is divided into networks referred to as autonomous systems. The network according to the invention can for example be an autonomous system or the part of the entire network in the area of responsibility of a service provider (e.g. ISP: internet service provider). In the case of a sub-network, service parameters for transmission via the entire network can be determined by means of a traffic control in the sub-networks and efficient communication between the sub-networks.

The term flow is generally used to refer to the traffic between a source and a destination. Here the flow relates to the ingress node and the egress node of the packet-oriented network, i.e. all the packets of a flow in the sense of our usage are transmitted via the same ingress node and the same egress node. The group of packets is for example assigned to a connection (in the case of a TCP/IP transmission defined by the IP address and port number of output and destination processes) and/or a class of service.

Ingress nodes of the packet-oriented network are nodes, via which the packets are routed into the network; egress nodes are network nodes, via which packets leave the network. For example a network can comprise edge nodes and internal nodes. If for example packets can enter or leave the network via all the edge nodes of the network, in this case the edge nodes of the network would be both network ingress nodes and network egress nodes.

An admissibility test according to the invention can be carried out by a control entity in a node or computers connected before the nodes. One control entity can thereby carry out the control functions for a plurality of nodes.

The admissibility check according to the invention allows traffic volume to be controlled within the network. With handling according to the invention for all the traffic routed via the network [lacuna] that an overall traffic volume develops, which would result in network overload and therefore delays and discarded packets. With known traffic distribution in the network, the limits for the admissibility checks can be selected such that no overload problems occur on any sub-link.

Restriction of the traffic volume can be undertaken in the sense of a transmission with negotiated quality of service features (service level agreements SLA), e.g. based on traffic prioritization.

To guarantee services with QoS data transmission, it is important to control the entire traffic volume within the network. This objective can be achieved by setting limit values for the traffic routed via the nodes for all network ingress nodes and network egress nodes. The limit values for the traffic routed via ingress and egress nodes can be related to values for maximum traffic volume on partial stretches (also frequently referred to as links or segments). The maximum value for the traffic volume on partial stretches will thereby generally be based not only on bandwidth but also on the network technology used, e.g. it should generally be taken into account whether it is a LAN (Local Area Network), a MAN (Metropolitan Area Network), a WAN (Wide Area Network) or a backbone network. Parameters other than transmission capacity, e.g. delays during transmission, also have to be taken into account for networks for real time applications. For example a degree of utilization of almost 100% for LAN with CSMA/CD (Carrier Sense Multiple Access (with) Collision Detection) is associated with delays, which generally exclude real time applications. The limit values for the traffic routed via the ingress and egress nodes can then be determined from the maximum values for the maximum traffic volume on partial stretches.

The relationship between the limit values for the traffic routed via the ingress and egress nodes and the traffic volume on partial stretches of the network is based in the preferred embodiment on the proportional traffic volume via the individual partial stretches of the network for pairs of network ingress nodes and network egress nodes. The proportional traffic volumes via the individual partial stretches of the network for the pairs of network ingress nodes and network egress nodes can be determined using empirical values or known characteristics of nodes and links. It is also possible to dimension the network to maintain the proportional traffic volumes via the individual partial stretches as a function of network ingress nodes and network egress nodes. The term traffic matrix is used in this context in traffic theory.

The invention has the advantage that information for the access control only has to be provided at ingress and egress nodes. For an ingress node or egress node this information includes for example the limit values and current values for the traffic routed via the respective nodes. The scope of the information is limited. It is simple to update the information. The internal nodes do not have to take over any functions in respect of the admissibility check. The method therefore requires significantly less outlay and is less complex than methods which provide admissibility checks for individual partial stretches. Unlike conventional methods such as ATM or MPLS no path has to be reserved within the network.

A relationship can be established between the traffic volumes between pairs of network ingress nodes and network egress nodes and the traffic volume on partial stretches of the network. The values for a maximum traffic volume on the partial stretches of the network can be used to define limits for the traffic volume between the pairs of network ingress nodes and network egress nodes and limit values for the traffic routed via the network ingress nodes and the traffic routed via the network egress nodes.

The relationship between the traffic volumes between pairs of network ingress nodes and network egress nodes and the traffic volume on partial stretches of the network can be established as an optimization problem with boundary conditions or secondary conditions in the form of inequations. The proportional traffic volume thereby flows via the individual partial stretches of the network to formulate the relationship between the traffic volumes between pairs of network ingress nodes and network egress nodes and the traffic volume on partial stretches of the network.

This formulation also allows the inclusion of further criteria in the form of inequations in the definition of the limits or limit values for the admissibility checks. For example when defining limits or limit values for the admissibility checks, conditions can be included in the form of inequations, which require a low traffic volume of high-priority traffic on partial stretches with longer delay times. Another example is that of an egress node, via which packets can be transmitted to a plurality of ingress nodes in other networks, i.e. the egress node has interfaces with a plurality of other networks. If ingress nodes of one of the subsequent networks can process a smaller data volume than the egress node, it can be ascertained by means of a further secondary condition in the form of an inequation that the traffic routed via the egress node to the ingress node exceeds the latter's capacity.

In a variant of the method according to the invention a further admissibility check is also provided, the admissibility check being implemented using a limit value for the traffic volume between the network ingress node and the network egress node for the flow. The group of data packets is permitted, if the results of all three checks are positive. To this end the check entities communicate with each other to use the results of the individual admissibility checks to make a decision relating to the transmission of the group of data packets.

According to one development of the invention, if a partial stretch fails, the limits or limit values for the admissibility check or admissibility checks are reset with the condition that no packets are transmitted via the failed partial stretch. As a result of resetting the limits, the traffic, which would otherwise have been transmitted via the failed link, is routed via other links, without an overload being caused by the rerouted traffic. It is thus possible to respond to failures in a flexible manner.

Precautionary protection against link failure can be ensured by the selection of limit values or limits. Limits or limit values, at which the traffic volume remains within a permissible frame even in the event of an incident—in other words parameters such as transit time delay and packet loss rate remain within ranges defined by the quality requirements for the data transmission—are thereby determined respectively for a plurality of possible incidents. The limits or limit values are then set to the minimum of the values for the incidents under examination. In other words each of the incidents is absorbed by the selection of the limits or limit values. The majority of incidents can for example include all link failures.

The said admissibility checks can also be carried out as a function of the class of service. It is for example possible to have a low-priority class of service, with which delays or discarded packets are anticipated, when network utilization is at a high level. On the other hand the limits are selected for high-priority traffic such that guarantees can be accepted with regard to transmission quality parameters.

The invention is described in more detail below with reference to a Figure in the context of an exemplary embodiment.

### BRIEF DESCRIPTION OF THE DRAWING

The sole FIGURE shows a network according to the invention.

### DETAILED DESCRIPTION OF THE INVENTION

The FIGURE shows a network according to the invention. Edge nodes are shown by solid circles, internal nodes by non-solid circles. Links are shown by connections between the nodes. By way of an example an ingress node is marked I, an egress node E and a link L. Some of the traffic between the nodes I and E is transmitted via the link L. The admissibility checks at the ingress node I and the egress node E together with the admissibility checks at other edge nodes ensure that no overload occurs at the link L.

Mathematical relationships are shown below for the method according to the invention. In practice limits or limit values are generally determined as a function of maximum link capacities. The reverse is considered below for a simpler mathematical representation, i.e. the dimensions of the links are calculated as a function of the limits or limit values. The solution to the reverse problem can then be achieved with numerical methods.

The following variables are used for the detailed representation below:
c(L): the traffic volume on the network section (link) L
aV(i,j,L): the proportional traffic volume via the link L of the
entire traffic volume between the ingress node i and the egress node j,
Ingress(i): the limit value for the traffic via the network ingress nodes i,
Egress(j): the limit value for the traffic via the egress nodes j,
δ (i,j): the traffic volume between the network ingress node i and the network egress node j.

The following inequations can be formulated:
The following applies for all i
   Σδ(i,j)≦Ingress(i), sum via all j. (1)
The following applies for all j
   Σδ(i,j)≦Egress(j), sum via all i. (2)
The following applies for all links L:
   C(L)=Σδ(i,j).aV(i,j,L), sum via all i and j. (3)

The simplex algorithm can be used to calculate the maximum c(L) satisfied by the inequations (2) to (4) for predefined Ingress(i) and Egress(j) values. Conversely for a set of limits or limit values Ingress(i), Egress(j) and BBB(i,j) it can be verified whether an inadmissibly high load can occur on a link L. The limits or limit values can then be modified to counteract the too high load.

The method according to the invention makes it possible to respond in a simple manner to incidents by modifying the limits or limit values. Thus if a link L fails, the relationship can exclude this link (e.g. by zeroing all aV(i,j.l) for this link L). By reformulating the connection it is possible to determine modified limits or limit values, which as admissibility criteria prevent overload within the network.

The following mathematical relationship can be formulated for the configuration with an additional admissibility check using a limit value for the traffic volume between network ingress nodes and network egress nodes:

above definitions apply. Also let
BBB(i,j) be the limit for the traffic volume between the ingress node i and the egress node j,
The following applies for all 2-tuples (i,j)
   δ(i,j)≦BBB(i,j). (4)

(3) applies again. Optimization is achieved under the conditions (1), (2) and (4). The conditions (4) are new in relation to the first formulation of the problem. As, when formulating the problem with the conditions (4), more conditions have to be satisfied, the maximum values for c(L) are less than or equal to those of the solution without the conditions (4). The additional conditions (4) restrict the scope of the solution and result with the same values for Ingress(i) and Egress(j) in smaller values c(L) in respect of the dimensions of the link L. When the problem is reversed, for the same predefined values for maximum capacity c(L) of the link L, the conditions (4) therefore generally result in higher values for the Ingress(i) and Egress(j). There is therefore greater flexibility with regard to determining limits and thus in respect of optimum utilization of the network.

1.-11. (canceled)

12. A method for limiting traffic in a packet-oriented network having a plurality of links, the method comprising:
performing two admissibility checks for a group of data packets of a flow to be transmitted via the network, wherein
the first admissibility check is carried out using a limit value for the traffic routed via the network ingress node of the flow, wherein
the second admissibility check is carried out using a limit value for the traffic routed via the network egress node of the flow, and wherein
transmission of the group of data packets is not permitted, if the transmission would result in traffic exceeding one of the two limit values.

13. The method according to claim 12, wherein limit values are determined for all network ingress nodes and network egress nodes for the traffic routed via the respective nodes.

14. The method according to claim 13, wherein
a relationship is established between the limit values for the traffic routed via network ingress nodes or network egress nodes with the traffic volume on the links of the network, and wherein
the limit values for the traffic routed via the network ingress nodes or network egress nodes are determined using values for maximum traffic volume on the links of the network.

15. The method according to claim 14, further comprising:
determining the proportional traffic volume via individual links of the network for pairs of network ingress nodes and network egress nodes; and
establishing the relationship between the limit values for the traffic routed via the network ingress nodes or network egress nodes with the traffic volume on links of the network using the values for proportional traffic volume via the individual links of the network.

16. The method according to claim 12, wherein
a relationship is established between the traffic volume between pairs of network ingress nodes and network egress nodes and the traffic volume on links of the network using inequations, wherein
an optimization method for the traffic volume on links of the network is implemented, wherein
the inequations are used as secondary conditions for optimization, and wherein
the proportional traffic volume via individual links of the network is used to establish the relationship between the traffic volume between pairs of network ingress nodes and network egress nodes and the traffic volume on links of the network.

17. The method according to claim 13, wherein
a relationship is established between the traffic volume between pairs of network ingress nodes and network egress nodes and the traffic volume on links of the network using inequations, wherein
an optimization method for the traffic volume on links of the network is implemented, wherein
the inequations are used as secondary conditions for optimization, and wherein
the proportional traffic volume via individual links of the network is used to establish the relationship between the traffic volume between pairs of network ingress nodes and network egress nodes and the traffic volume on links of the network.

18. The method according to claim 14, wherein
a relationship is established between the traffic volume between pairs of network ingress nodes and network egress nodes and the traffic volume on links of the network using inequations, wherein
an optimization method for the traffic volume on links of the network is implemented, wherein
the inequations are used as secondary conditions for optimization, and wherein
the proportional traffic volume via individual links of the network is used to establish the relationship between the traffic volume between pairs of network ingress nodes and network egress nodes and the traffic volume on links of the network.

19. The method according to claim 15, wherein
a relationship is established between the traffic volume between pairs of network ingress nodes and network egress nodes and the traffic volume on links of the network using inequations, wherein
an optimization method for the traffic volume on links of the network is implemented, wherein
the inequations are used as secondary conditions for optimization, and wherein
the proportional traffic volume via individual links of the network is used to establish the relationship between the traffic volume between pairs of network ingress nodes and network egress nodes and the traffic volume on links of the network.

20. The method according to claim 12, further comprising:
performing a further admissibility check using a limit value for the traffic volume between the network ingress node and the network egress node for the flow.

21. The method according to claim 13, further comprising:
performing a further admissibility check using a limit value for the traffic volume between the network ingress node and the network egress node for the flow.

22. The method according to claim 14, further comprising:
performing a further admissibility check using a limit value for the traffic volume between the network ingress node and the network egress node for the flow.

23. The method according to claim 15, further comprising:
performing a further admissibility check using a limit value for the traffic volume between the network ingress node and the network egress node for the flow.

24. The method according to claim 16, further comprising:
performing a further admissibility check using a limit value for the traffic volume between the network ingress node and the network egress node for the flow.

25. The method according to claim 20, wherein
a relationship is established between the traffic volume between pairs of network ingress nodes and network egress nodes and the traffic volume on the links of the network, and wherein
values for maximum traffic volume on the links of the network are used to determine limits for the traffic volume between the pairs of network ingress nodes and network egress nodes and limit values for the traffic routed via the network ingress nodes and the traffic routed via the network egress nodes.

26. The method according to claim 12, wherein, if a link fails, the limits or the limit values for the admissibility check or admissibility checks are reset with the condition that no packets are transmitted via the failed link.

27. The method according to claim 13, wherein, if a link fails, the limits or the limit values for the admissibility check or admissibility checks are reset with the condition that no packets are transmitted via the failed link.

28. The method according to claim 12, wherein, for at least one admissibility check, limits or limit values dependent on a class of service of the group of packets are used.

29. The method according to claim 13, wherein, for at least one admissibility check, limits or limit values dependent on a class of service of the group of packets are used.

30. The method according to claim 12, wherein
for a majority of possible incidents limits or limit values respectively are determined, at which the traffic volume remains within a permitted frame, even in the event of an incident, and wherein
the limits or limit values are set to the minimum of the values for the incidents under examination.

31. The method according to claim 16, wherein
at least one further relationship is established using an inequation, the further relationship expresses a traffic limitation on a link of the network or a link going away from the network, and wherein
the optimization method is performed by using a condition regarding said further relationship.
